(19) United States
(12) Patent Application Publication
(10) Pub. No.: US 2018/0366032 A1
(43) Pub. Date: Dec. 20, 2018

(54) Electronic Mirror Assembly

(71) Applicants: Lorena Young, Brighton, AL (US); Wanda Mitchell, Brighton, AL (US)

(72) Inventors: Lorena Young, Brighton, AL (US); Wanda Mitchell, Brighton, AL (US)

(21) Appl. No.: 15/624,092

(22) Filed: Jun. 15, 2017

(51) Int. Cl. G09B 21/00; G06F 3/16; G06F 3/01; G06F 3/0484; G06F 3/0488

(52) U.S. Cl. CPC G09B 21/006; G06F 3/167; G09B 21/008; G06F 3/04842; G06F 3/0488; G06F 3/011

(57) ABSTRACT

A electronic mirror assembly for integrating a display into a mirror includes a panel that may be hung on a vertical support surface. A mirror is coupled to the panel and the mirror is configured to reflect light. Moreover, the mirror facilitates the user to view themselves. A display unit is coupled to the mirror and the display unit is in electrical communication with an extrinsic communication network. The display unit is selectively turned on. Thus, the mirror display indicia thereby facilitating the user to view the indicia when the user is viewing themselves in the mirror.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to mirror devices and more particularly pertains to a new mirror device for integrating a display into a mirror.

### BRIEF SUMMARY OF THE INVENTION

An embodiment of the disclosure meets the needs presented above by generally comprising a panel that may be hung on a vertical support surface. A mirror is coupled to the panel and the mirror is configured to reflect light. Moreover, the mirror facilitates the user to view themselves. A display unit is coupled to the mirror and the display unit is in electrical communication with an extrinsic communication network. The display unit is selectively turned on. Thus, the mirror displays indicia thereby facilitating the user to view the indicia when the user is viewing themselves in the mirror.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an electronic mirror assembly according to an embodiment of the disclosure.

FIG. 2 is a front in-use view of an embodiment of the disclosure.

FIG. 3 is a left side view of an embodiment of the disclosure.

FIG. 4 is a schematic view of an embodiment of the disclosure.

### DETAILED DESCRIPTION OF THE INVENTION

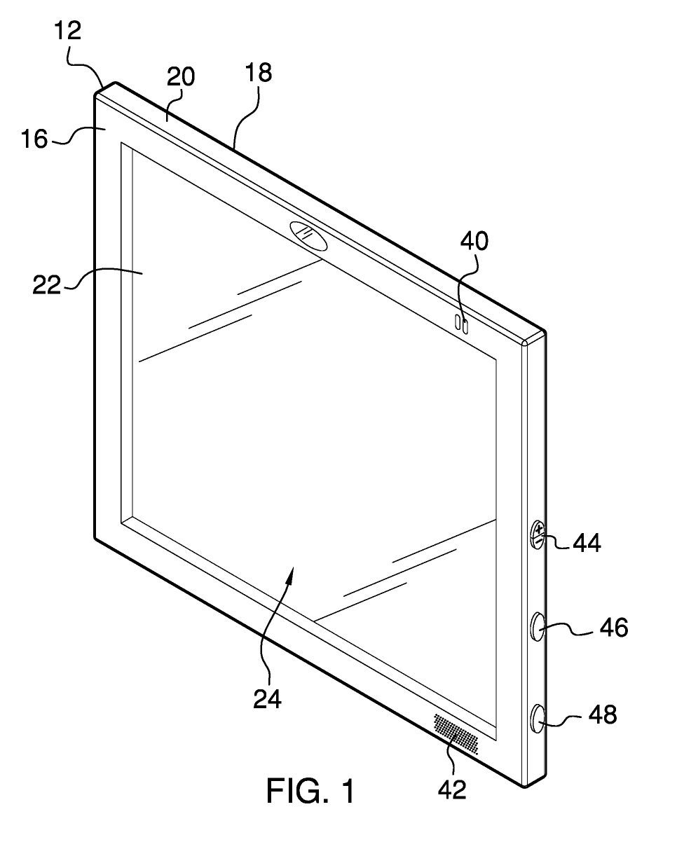

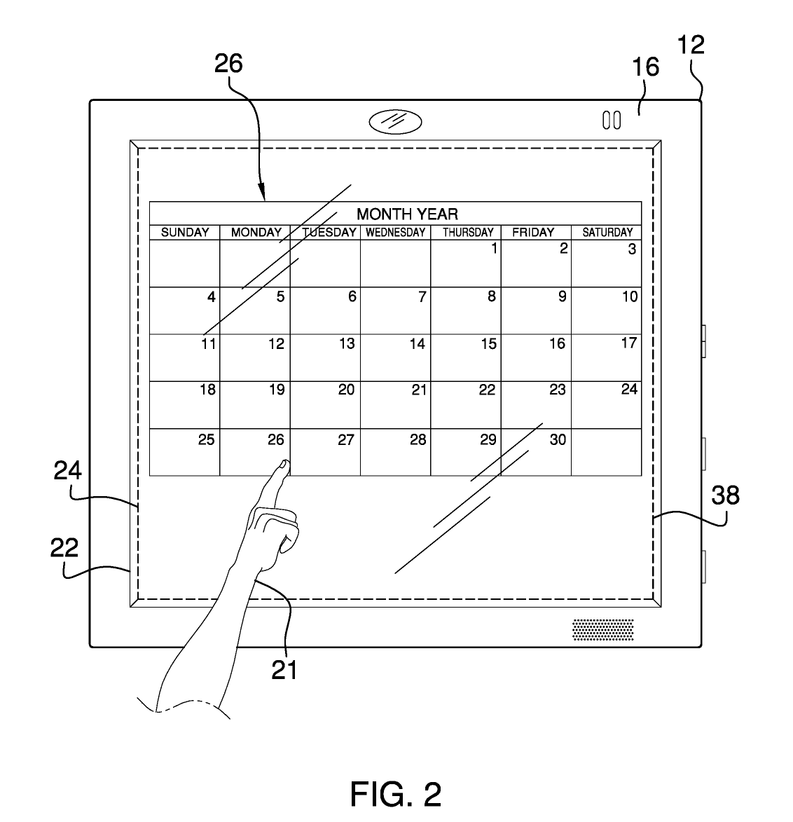

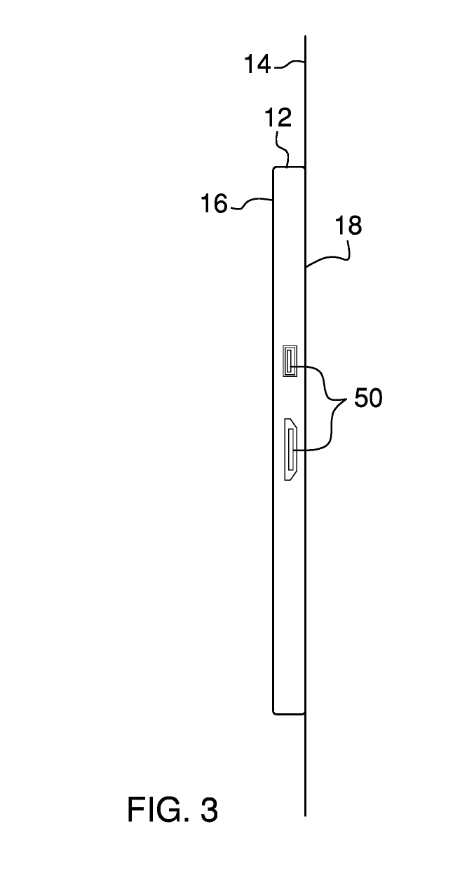

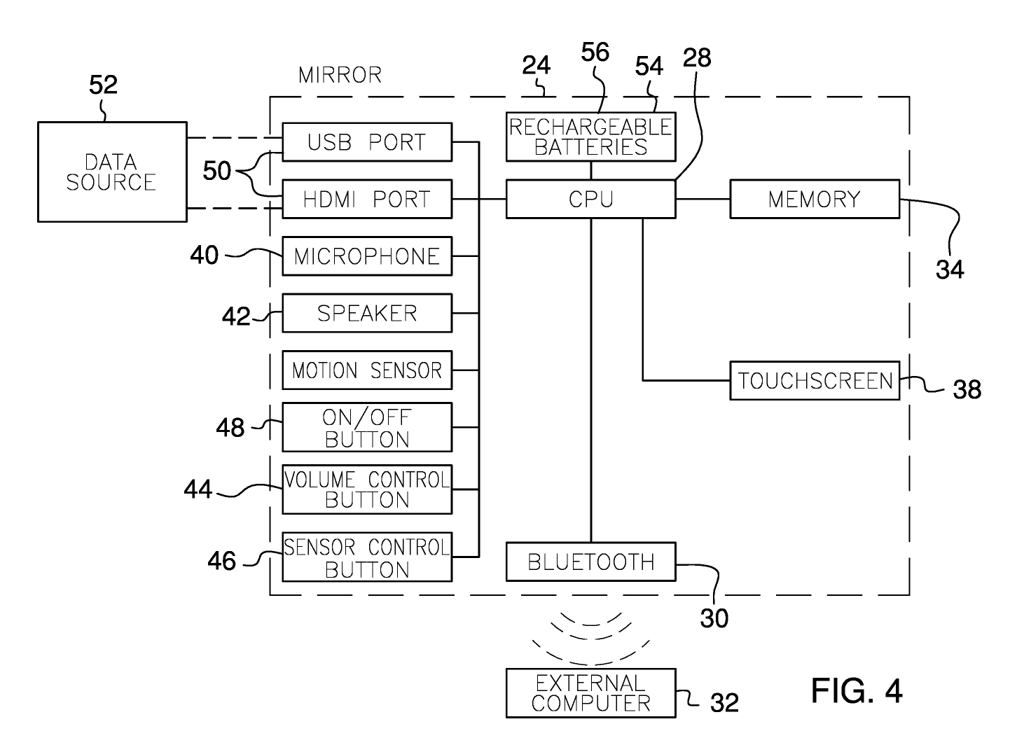

With reference now to the drawings, and in particular to FIGS. 1 through 4 thereof, a new mirror device embodying the principles and concepts of an embodiment of the disclosure and generally designated by the reference numeral 10 will be described.

As best illustrated in FIGS. 1 through 4, the electronic mirror assembly 10 generally comprises a panel 12 that may be hung on a vertical support surface 14. The vertical support surface 14 may be wall in a bathroom and any other room in a building. The panel 12 has a front side 16, a back side 18 and a peripheral edge 20 extending therebetween. The back side 18 is attached to the vertical support surface 14 thereby facilitating the front side 16 to be visible to a user 21. Moreover, the panel 12 may have a width of at least 80.0 cm and a height of at least 70.0 cm.

A mirror 22 is coupled to the panel 12 and the mirror 22 reflects light thereby facilitating the mirror 22 to the user 21 to view themselves. The mirror 22 is positioned on the front side 16 of the panel 12 and the mirror 22 may comprise an electronic, smart mirror that is constructed of optical glass. A display unit 24 is coupled to the mirror 22 and the display unit 24 is in electrical communication with an extrinsic communication network 32. The display unit 24 is selectively turned on such that the mirror 22 selectively displays indicia 26. In this way the user 21 may view the indicia 26 when the user 21 is viewing themselves in the mirror 22. Additionally, the indicia 26 may comprise a monthly calendar.

The display unit 24 comprises a processor 28 that is positioned within the panel 12. The processor 28 selectively generates a calendar sequence and the processor 28 may be an electronic processor or the like. A transceiver 30 is positioned within the panel 12 and the transceiver 30 is electrically coupled to the processor 28. The transceiver 30 is in electrical communication with the extrinsic communication network 32 thereby facilitating the transceiver 30 to download calendar data from the extrinsic communication network 32. The extrinsic communication network 32 may the internet and any other means of wireless, electronic data transmission. Moreover, the transceiver 30 may be a radio frequency transceiver 30 that employs Bluetooth communication protocols and a WPAN signal. The transceiver 30 may stream video from the internet or the like thereby facilitating television shows and movies to be viewed on the mirror 22.

An electronic memory 34 is positioned within the panel 12 and the electronic memory 34 is electrically coupled to the processor 28. The electronic memory 34 stores the calendar data downloaded by the transceiver 30. Additionally, the electronic memory 34 may comprise RAM, a hard disk drive and any other electronic memory 34. A motion sensor 36 is coupled to the front side 16 of the panel 12 and the motion sensor 36 senses motion. The motion sensor 36 is electrically coupled to the processor 28 and the processor 28 generates the calendar sequence when the motion sensor 36 senses motion. The motion sensor 36 may be an electronic motion sensor of any conventional design.

A touch screen 38 is integrated into the mirror 22 and the touch screen 38 is selectively manipulated. The touch screen 38 is electrically coupled to the processor 28. Moreover, the touch screen 38 is turned on when the processor 28 generates the calendar sequence. Thus, the touch screen 38 displays indicia 26 relating to the calendar when the user 21 stands in front of the mirror 22.

The touch screen 38 is manipulated to selectively enter appointments and other events corresponding to selected days of the calendar into the electronic memory 34. In this way the touch screen 38 may display the appointments and other events on the calendar. The touch screen 38 may comprise an LED or the like and the touch screen 38 may be a unitary structure with respect to the mirror 22. Additionally, the touch screen 38 may be a discrete structure with respect to the mirror 22. The touch screen 38 may selectively display a virtual Qwerty keyboard for entering the appointments and other events.

A microphone 40 is coupled to the front side 16 of the panel 12 and the microphone 40 detects audible sounds. The electronic memory 34 may store data corresponding to voice commands. Moreover, the microphone 40 is electrically coupled to the processor 28 such that microphone 40 actuates the processor 28 when the microphone 40 detects corresponding voice commands. Thus, the processor 28 may be controlled independently of the touch screen 38. A speaker 42 is coupled to the panel 12 and the speaker 42 selectively emits audible sound. The speaker 42 is electrically coupled to the processor 28 and the speaker 42 may be an electronic speaker 42 or the like.

A volume button 44 is coupled to the panel 12 and the volume button 44 is selectively manipulated. The volume button 44 is electrically coupled to the speaker 42 such that the volume button 44 adjusts the speaker 42 between a minimum volume and a maximum volume. A sensor button 46 is coupled to the panel 12 and the sensor button 46 is selectively manipulated. The sensor button 46 is electrically coupled to the motion sensor 36 such that the sensor button 46 turns the motion sensor 36 on and off. A power button 48 is coupled to the panel 12 and the power button 48 is selectively manipulated. The power button 48 is electrically coupled to the processor 28 such that the power button 48 turns the processor 28 on and off.

A visually impaired user 21 may enter the appointments and other events into the calendar with the verbal commands instead of manipulating the touch screen 38. Additionally, the speaker 42 emits audible sounds that correspond to the appointments and other events. Thus, the visually impaired user 21 is notified of the appointments and events as they occur on the corresponding dates.

A plurality of data ports 50 is provided and each of the data ports 50 is coupled to the panel 12. Each of the data ports 50 is electrically coupled to the processor 28 and each of the data ports 50 is selectively electrically coupled to a data source 52. In this way data may be downloaded from the data source 52 into the electronic memory 34. The plurality of data ports 50 may include a USB port, an HDMI port and any other conventional data port. The data source 52 may be a personal computer and any other means of electronic data storage. A power supply 54 is coupled to the panel 12 and the power supply 54 is electrically coupled to the processor 28. The power supply 54 comprises at least one battery 56 and the battery 56 may be a rechargeable battery 56 of any conventional design.

In use, the panel 12 is hung on the vertical support surface 14 and the panel 12 is positioned to be at eye level with the user 21. In this way the mirror 22 is positioned to reflect the user's 21 face for the purposes of personal hygiene, applying makeup and any other reason for employing a mirror 22. The motion sensor 36 turns the touch screen 38 on when the motion sensor 36 senses motion. Thus, the calendar is displayed on the mirror 22 when the user 21 approaches the mirror 22. The user 21 touches the mirror 22 to enter appointments and other events into the calendar. The sensor button 46 is manipulated to turn the motion sensor 36 off when the user 21 wishes to use the mirror 22 without having the calendar being displayed on the mirror 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electronic mirror assembly being configured to selectively display a calendar, said assembly comprising:
a panel being configured to be hung on a vertical support surface;
a mirror being coupled to said panel wherein said mirror is configured to reflect light thereby facilitating said mirror to the user to view themselves; and
a display unit being coupled to said mirror, said display unit being configured to be in electrical communication with an extrinsic communication network, said display unit being selectively turned on wherein said mirror is configured to display indicia thereby facilitating the user to view the indicia when the user is viewing themselves in said mirror.

2. The assembly according to claim 1, wherein said panel has a front side, a back side and a peripheral edge extending therebetween, said back side being configured to be attached to the vertical support surface thereby facilitating said front side to be visible to a user.

3. The assembly according to claim 1, wherein said display unit comprises a processor being positioned within said panel, said processor selectively generating a calendar sequence.

4. The assembly according to claim 3, further comprising a transceiver being positioned within said panel, said transceiver being electrically coupled to said processor, said transceiver being configured to be in electrical communication with the extrinsic communication network thereby facilitating said transceiver to download calendar data from the extrinsic communication network.

5. The assembly according to claim 4, further comprising an electronic memory being positioned within said panel, said electronic memory being electrically coupled to said processor wherein said electronic memory is configured to store the calendar data downloaded by said transceiver.

6. The assembly according to claim 3, further comprising a motion sensor being coupled to said front side of said panel wherein said motion sensor is configured to sense motion, said motion sensor being electrically coupled to said processor, said processor generating said calendar sequence when said motion sensor senses motion.

7. The assembly according to claim 5, further comprising a touch screen being integrated into said mirror wherein said touch screen is configured to be manipulated, said touch screen being electrically coupled to said processor, said touch screen being turned on when said processor generates said calendar sequence wherein said touch screen is configured to display indicia relating to the calendar, said touch screen selectively entering appointments and other events corresponding to selected days of the calendar into said electronic memory when said touch screen is manipulated thereby facilitating said touch screen to display the appointments and other events on the calendar.

8. The assembly according to claim 3, further comprising a microphone being coupled to said front side of said panel wherein said microphone is configured to detect voice commands, said microphone being electrically coupled to said processor such that microphone actuates said processor when said microphone detects corresponding voice commands.

9. The assembly according to claim 3, further comprising a speaker being coupled to said panel wherein said speaker is configured to emit audible sound, said speaker being electrically coupled to said processor.

10. The assembly according to claim 9, further comprising a volume button being coupled to said panel wherein said volume button is configured to be manipulated, said volume button being electrically coupled to said speaker such that said volume button adjusts said speaker between a minimum volume and a maximum volume.

11. The assembly according to claim 6, further comprising a sensor button being coupled to said panel wherein said sensor button is configured to be manipulated, said sensor button being electrically coupled to said motion sensor such that said sensor button turns said motion sensor on and off.

12. The assembly according to claim 3, further comprising a power button being coupled to said panel wherein said power button is configured to be manipulated, said power button being electrically coupled to said processor such that said power button turns said processor on and off.

13. The assembly according to claim 3, further comprising a plurality of data ports, each of said data ports being coupled to said panel, each of said data ports being electrically coupled to said processor, each of said data ports being configured to be electrically coupled to a data source thereby facilitating data to be downloaded from the data source into said electronic memory.

14. The assembly according to claim 3, further comprising a power supply being coupled to said panel, said power supply being electrically coupled to said processor, said power supply comprising at least one battery.

15. An electronic mirror assembly being configured to selectively display a calendar, said assembly comprising:
a panel being configured to be hung on a vertical support surface, said panel having a front side, a back side and a peripheral edge extending therebetween, said back side being configured to be attached to the vertical support surface thereby facilitating said front side to be visible to a user;
a mirror being coupled to said panel wherein said mirror is configured to reflect light thereby facilitating said mirror to the user to view themselves, said mirror being positioned on said front side of said panel; and
a display unit being coupled to said mirror, said display unit being configured to be in electrical communication with an extrinsic communication network, said display unit being selectively turned on wherein said mirror is configured to display indicia thereby facilitating the user to view the indicia when the user is viewing themselves in said mirror, said display unit comprising:
a processor being positioned within said panel, said processor selectively generating a calendar sequence,
a transceiver being positioned within said panel, said transceiver being electrically coupled to said processor, said transceiver being configured to be in electrical communication with the extrinsic communication network thereby facilitating said transceiver to download calendar data from the extrinsic communication network,
an electronic memory being positioned within said panel, said electronic memory being electrically coupled to said processor wherein said electronic memory is configured to store the calendar data downloaded by said transceiver,
a motion sensor being coupled to said front side of said panel wherein said motion sensor is configured to sense motion, said motion sensor being electrically coupled to said processor, said processor generating said calendar sequence when said motion sensor senses motion,
a touch screen being integrated into said mirror wherein said touch screen is configured to be manipulated, said touch screen being electrically coupled to said processor, said touch screen being turned on when said processor generates said calendar sequence wherein said touch screen is configured to display indicia relating to the calendar, said touch screen selectively entering appointments and other events corresponding to selected days of the calendar into said electronic memory when said touch screen is manipulated thereby facilitating said touch screen to display the appointments and other events on the calendar,
a microphone being coupled to said front side of said panel wherein said microphone is configured to detect voice commands, said microphone being electrically coupled to said processor such that microphone actuates said processor when said microphone detects corresponding voice commands,
a speaker being coupled to said panel wherein said speaker is configured to emit audible sound, said speaker being electrically coupled to said processor,
a volume button being coupled to said panel wherein said volume button is configured to be manipulated, said volume button being electrically coupled to said speaker such that said volume button adjusts said speaker between a minimum volume and a maximum volume,
a sensor button being coupled to said panel wherein said sensor button is configured to be manipulated, said sensor button being electrically coupled to said motion sensor such that said sensor button turns said motion sensor on and off,
a power button being coupled to said panel wherein said power button is configured to be manipulated, said power button being electrically coupled to said processor such that said power button turns said processor on and off,
a plurality of data ports, each of said data ports being coupled to said panel, each of said data ports being electrically coupled to said processor, each of said data ports being configured to be electrically coupled to a data source thereby facilitating data to be downloaded from the data source into said electronic memory, and
a power supply being coupled to said panel, said power supply being electrically coupled to said processor, said power supply comprising at least one battery.
